(19) United States
(12) Patent Application Publication
(10) Pub. No.: US 2025/0067382 A1
(43) Pub. Date: Feb. 27, 2025

(54) Pipeline Service System Including Inspection Tools to Evaluate Pipeline Flow and Assess Performance of Structural Tools during Hot Tapping Operation

(71) Applicant: TDW Delaware, Inc., Wilmington, DE (US)

(72) Inventors: Roger L. Poe, Beggs, OK (US); Jon Maslen, Sand Springs, OK (US); Tyrone Schurr, Broken Arrow, OK (US); Terry Britton, Owasso, OK (US)

(21) Appl. No.: 18/815,058

(22) Filed: Aug. 26, 2024

Related U.S. Application Data
(60) Provisional application No. 63/578,580, filed on Aug. 24, 2023.

(51) Int. Cl. F16L 55/48; G01N 21/954

(52) U.S. Cl. CPC F16L 55/48; G01N 21/954

(57) ABSTRACT

A pipeline inspection tool 300 of this disclosure is adapted for use a first pipeline service machine 200, including a control bar 210, when connected to a first valve 206 providing access to an interior of a pipe 52. The tool includes a connector 302 adapted for use in a pressurized pipeline, the connector including an electrical wire interconnect 308 and connectable at one end 304 to a distal end 212 of the control bar and connectable at another end 306 to a module 310, 310A, 310B of the pipeline inspection tool, module including a pressurized housing 314 containing the inspection tool. The module also includes a bulkhead 316 having a square O-ring 318 and a rod 320 that extends through the bulkhead to place the square O-ring in compression. In some embodiments, the tool includes two modules 310A, 310B, one containing a camera 330, the other containing lights 340.

### CROSS-REFERENCE TO CO-PENDING APPLICATIONS

This application claims priority to, and benefit of, U.S. Application No. 63/578,580, filed Aug. 24, 2023.

### BACKGROUND

Oil and natural gas transmission lines can range in size from 6 to 48 inches in diameter, and sometimes larger. The liquids being transported through these lines typically travel at a rate of about 5 mph the natural gas typically travels at about 20 mph. However, in the case of natural gas, some pipeline operators may choose to run velocities 2 to 4 times this. As the velocity increases, the risk of the flow picking up, and carrying, slugs of liquids residing in low spots of the pipeline increases. Additionally, the increase in momentum with higher velocities is significant.

Additionally, in a growing number of applications hydrogen is being mixed into the natural gas stream and may, in some cases, replace upwards of 20% of the natural gas volume. Because hydrogen and natural gas have significantly different molecular weights, they have a tendency to separate from one another as they travel through the line. Separation is problematic because hydrogen has a wider range of flammable concentrations and lower ignition energy than natural gas.

Last, natural gas travels at pressures anywhere from 35 to 1500 psi (which in turn compresses the volume of gas). At 1500 psi, a plugging tool inserted into 30-inch line experiences about 1.1 MM pounds of force as the seal is energized. This plugging tool must rotate into a sealing position as it enters the interior of the pipe through a hot tap valve and maintain sealing engagement with the pipe wall when under this force.

Because of the high pressure, the potential for hydrogen separation, and the varying velocities along the line and the potential for liquid slugs to be carried in the flow, a pipeline service provider follows certain procedures intended to mitigate risks and increase safety during hot tapping operations. Hot tapping, sometimes called pressure tapping, is a method of making a connection to existing piping or pressure vessels while minimally interrupting product flow or emptying of that section of pipe or vessel. Hot tapping permits the pipe or pressure vessel to continue to be in operation while maintenance or modifications are being performed. The method can also be used to drain off pressurized casing fluids and add test points or various sensors such as temperature and pressure. Hot taps can range from a ½ inch hole designed for something as simple as quality control testing, to more than a 48 inch tap for the installation of a variety of ports, valves, t-sections or other pipes. In some applications, where specific tools are designed, the hot tap can be larger than 48 inches.

In almost all cases, the pipeline service provider relies upon general pipeline product flow information provided to it by the pipeline operator, using the information to select the proper hot tap tools and determine whether a hot tap can be safely made. During the hot tap, the service provider may have to depend upon sounds and pressures to interpret what is occurring within the line and may learn that actual pipeline conditions at the hot tap site vary from the general information provided. In some cases, the service provider may have to abort the hot tap operation. In other cases, the service provider may later discover the structural tool that had been set in the line is not performing as expected because it never set as intended or was inadequate for the actual pipeline conditions. An additional measure of safety and risk mitigation could result from the pipeline operator knowing the exact conditions at the hot tap site both prior to and during the hot tapping operation. Therefore, there is a need for a camera and measurement system that is insertable into an interior of a pipeline and used to inspect and monitor pipeline conditions as well as structural tool use during hot tapping operations.

A variety of prior art cameras are available for use in pipeline inspection, either as endoscopes or as crawlers. None of these camera systems are used in connection with hot tapping. Robocam does market a pipeline endoscope, PROCAM-W, that is connected to a cable and inserted into through a hot tap of a water supply pipe under pressure. The Robocam endoscope does not evaluate flow or the performance of a structural tool inserted through the hot tap.

U.S. Pat. No. 7,316,176 B2 to TDW Delaware, Inc. discloses a remote monitor system for a longitudinally positioned control bar that includes “a video camera positioned within the explosion proof enclosure having a lens with a visual path through the window and in alignment with the housing aperture.” The camera provides “control bar position indicating images.” See Abstract and FIGS. 1 & 2. However, the camera is not connected to the control bar, nor does it enter an interior of the pipe servicing machine or that of the pipe being tapped to evaluate flow or the performance of a structural tool. There is no exposure to pressure or product.

U.S. Pat. No. 8,069,874 B2 to Cudd Pressure Control discloses one or more cameras located external to an underwater pipeline service machine to monitor a hot tapping operation. The camera may allow a user to monitor the extension of drill bit by observing the movement of lead with respect to external reference markings or allow the user to monitor the rotation of a polished rod by observing the substantially matching rotation of the pattern on a lead screw drive hub. None of the cameras enter an interior of the pipe servicing machine or that of the pipe being tapped. There is no exposure to pressure or product.

U.S. Pat. No. 10,851,605 B2 to AES-EOT Equipment Holdings discloses use of a video camera in connection with underwater hot tapping, but its use is limited to allow a dive supervisor topside to see the seal tip, make sure its level with the pipe, and assist the diver when installing the mandrel. The camera does not enter an interior of the pipe servicing machine or that of the pipe being tapped, nor does it evaluate flow or the performance of a structural tool. There is no exposure to pressure or product.

Last, KR 100977382 B1 discloses use of a camera in connection with an electromagnetic assembly for removing chips produced by drilling during hot tapping. The camera does not evaluate flow or monitor or evaluate the performance of a structural tool or operations to insert the structural tool.

### SUMMARY

Embodiments of this disclosure comprise a pipeline inspection tool adapted for use within an interior of a pipeline under pressure, inserted by a control bar through a fitting located along a sidewall of a section of pipeline, and arranged to monitor hot tapping, pipeline isolation, and plugging operations. The inspection tool may be an imaging tool, a velocity measurement tool, an isokinetic measurement tool, a magnetic flux tool, a sound measurement tool for high frequency, oxygen or gas measurement tool, or a gas mixture measurement tool. In some embodiments, the imaging tool is a camera.

The hot tapping, pipeline isolation and plugging operations make use of structural tools, known in the art, to perform the operations. The structural tools are inserted into an interior of the pipeline using a pipeline service machine, known in the art, connected to a platform that includes a fitting and valve. Another pipeline service machine and platform, spaced from the structural are then used to monitor the operations, the structural tools or its service machine and platform, or other pipeline conditions or features of interest.

For the purposes of this disclosure, the inspection tool and its service machine and platform may be referred to as the first tool, service machine or platform; the structural tool and its service machine and platform may be referred to as the second tool, service machine or platform. Persons of skill in the art would understand the use of first and second is arbitrary and simply used here as a naming convention. Similarly inspection tool modules may be labeled first and second or A and B, again simply as a naming convention and not indicative of their order along the inspection tool.

Embodiments of a pipeline service system of this disclosure may include a first hot tap valve connected to the pipe for providing access through a sidewall of the pipe, a first pipeline service machine adapted for connection to the hot tap valve, and a first tool for insertion into the interior of the pipeline through the valve. The first tool is an inspection tool and includes a connector with one end adapted for connection to a lower end of a control bar of the first pipeline service machine and the other end adapted for connection to the first tool. The connector is adapted for use in a pressurized pipeline environment and includes an electric wire interconnect.

The pipeline service system may also include a second hot tap valve connected to the pipeline and spaced from, and in proximity to, the first hot tap; a second pipeline service machine adapted for connection the second hot tap valve, and a second tool for tapping, plugging, or completing the hot tapping operation. The second tool, therefore, is a structural tool.

In embodiments of this disclosure, the inspection tool includes a module having a pressurized housing that contains at least one inspection tool. In some embodiments, inspection tool may include two or more modules or stages, for example, an imaging tool or camera module and a light module, the two or more modules being connected to, and coaxial with, one another and the control bar. A bulkhead or divider is used to separate each stage and seal against the housing.

The tool connects to a connector suitable for use in pressurized pipeline environments and containing an electrical wire interconnect system, thereby placing it in communication with a power source associated with the pipeline service machine as well as a controller, the tool and its modules or stages being selectively controllable by the controller. The controller includes non-transitory machine- or computer-readable storage medium containing instructions thereon.

A second light module can be connected to the imaging tool or camera module, the camera module being located between the two light modules. The second light module, like the first, can be selectively controllable by the controller. The first module can be controlled to direct light in a first direction and the second light module can be controlled to direct light in the same or a different direction.

A second imaging tool or camera module may be connected to another end of the second light module, the second camera being selectively controllable by the controller. One of the first and second camera modules can be arranged to capture images in a first direction, another of the first and second camera modules can be arranged to capture images in a second direction. The first direction and second direction may be selected, respectively, from the group consisting of a radial direction and an axial direction. The first direction and the second direction may be the same direction. The camera modules may be arranged or controlled to capture images at different angles.

In embodiments of a method of this disclosure, the method comprises inserting a pipeline inspection tool of this disclosure into a pressurized interior of the pipeline through a first hot tap valve (sliding gate or ball valve) connected to the pipeline; placing the first tool in communication with a power source or controller or both, the controller; collecting data within the interior of the pipeline using the first tool; analyzing the collected data. The method may also include, if the analyzed data indicates a safe condition, then inserting a structural tool through the second hot tap valve (sliding gate or ball valve); deploying the structural tool; and monitoring the deploying. In some embodiments, the inspection tool may monitor the hot tapping operation, monitor a pipeline plug subsequent to the hot tapping, or removal of the pipeline plug and completion of the service.

### BRIEF DESCRIPTION OF THE DRAWINGS

FIG. 1 is an example embodiment of a pipeline service system of this disclosure. A first (inspection tool) pipeline service machine is spaced in an axial direction from a second (structural tool) pipeline service machine. The first pipeline service machine includes a first tool for inspecting a condition of the pipe, pipeline product or flow, or a second (structural tool) of the second pipeline service machine. The structural tool may be a drilling or hot tapping tool, a plugging tool, or a completion tool. In embodiments, the second pipeline service machine is typically the main service machine and is of a size appropriate for hot tapping of the pipeline. The first pipeline service machine is of a size more appropriate for hot tapping a smaller pipeline. In embodiments of this disclosure, the inspection tool may be sized for insertion into fittings less than 2 inches in diameter.

FIG. 2 is an example embodiment of a first tool of this disclosure. The first tool may be an imaging tool or camera module adapted for connection to a control bar of the first pipeline service machine. In its simplest form, the inspection tool may include a top section comprising a connector that attaches to a distal end of a control or tapping bar, the connector including an electrical wire interconnect system. When configured as an imaging tool, the tool may include a first lighting module and a first camera module. Similar modular arrangements can be used to configure the tool as a velocity measurement tool, an isokinetic measurement tool, a magnetic flux tool, a sound measurement tool for high frequency, oxygen or gas measurement tool, or a gas mixture measurement tool (or some combination thereof).

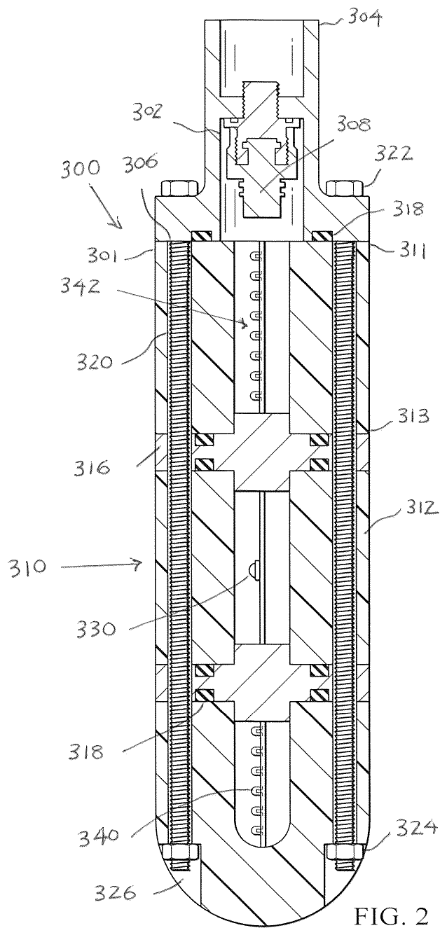

FIG. 3A is an enlarged view of the top section of the imaging tool of FIG. 2. The top section may comprise a connector that offers performance comparable to MIL-DTL-38999 such as a GLENAIR® MIGHTY MOUSE™, panel receptacle, high pressure connector or its equivalent.

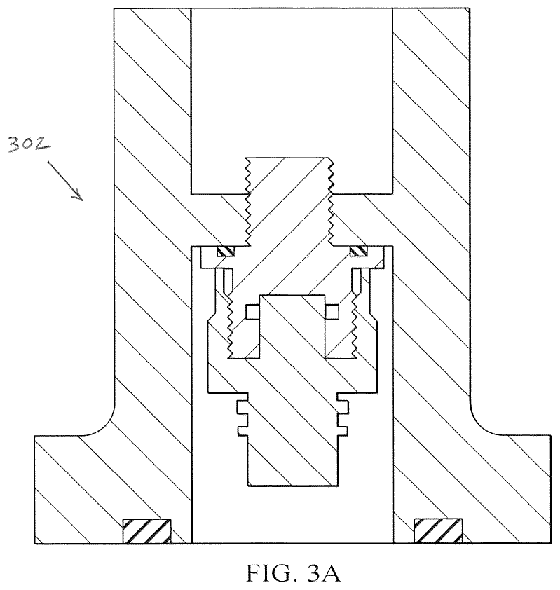

FIG. 3B is a top plan view of FIG. 3A.

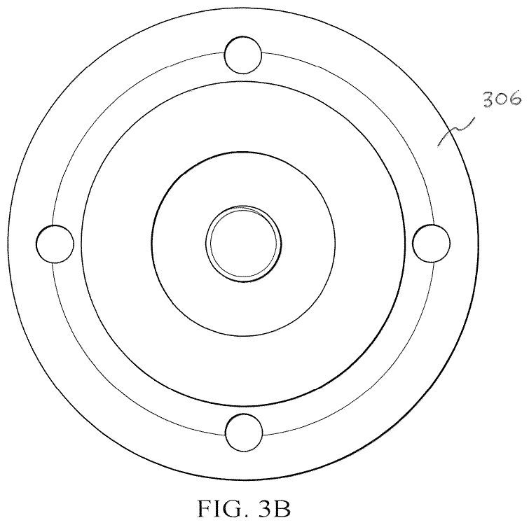

FIG. 3C is a bottom plan view of FIG. 3A.

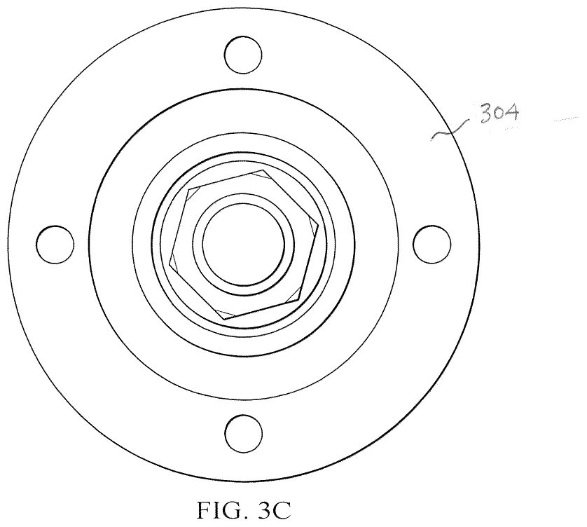

FIG. 4 is an example flow diagram of an embodiment of a method of this disclosure.

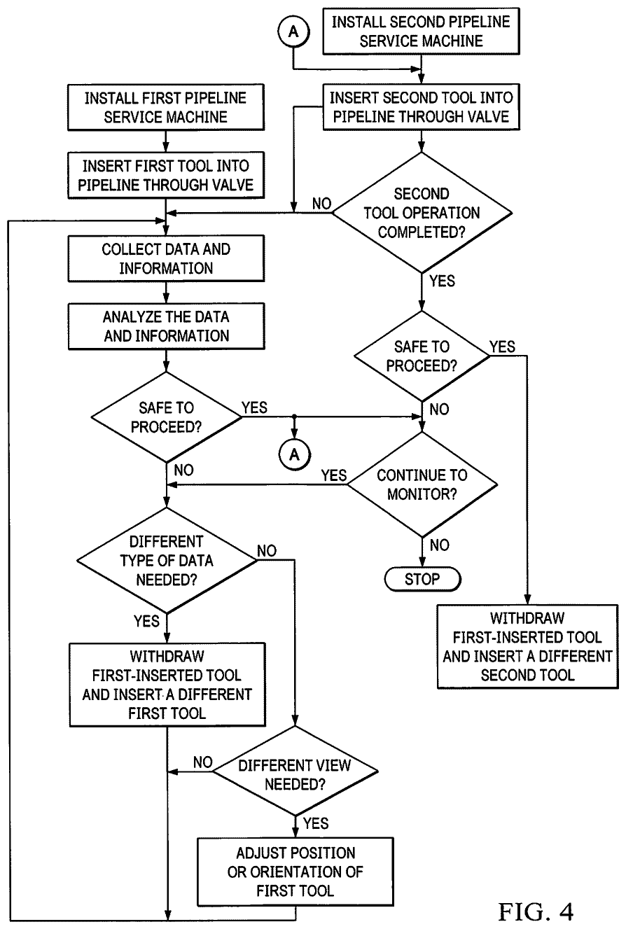

FIG. 5 is another embodiment of an imaging tool of this disclosure.

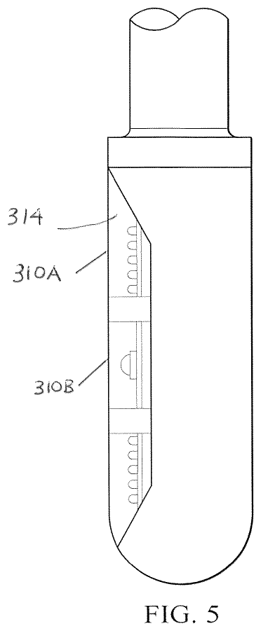

### ELEMENT NUMBERING USED IN THE DRAWINGS AND DETAILED DESCRIPTION

52 Pipeline
54 Product flow
56 Pipeline clamp or saddle
58 Second pipeline clamp or saddle
60 Flange or fitting
100 Tapping machine (second pipeline service machine used to insert structural tools)
101 Platform
102 Pressure gauge
104 Bleeder valve
106 Sliding gate or ball valve (hot tap valve)
110 Equalization piping
112 Equalization valve
114 Pressure gauge
116 Tapping valve
200 Tapping machine (first pipeline service machine used to insert inspection tools)
201 Platform
204 Bleeder valve
206 Sliding gate or ball valve (hot tap valve)
210 Control bar
212 Distal (lower) end of control bar
256 Pipeline clamp or saddle
260 Flange or fitting
262 Threaded valve adapter
300 Inspection tool or first tool
301 Upper end or top section
302 Connector (housing)
304 Proximal (upper) end of connector
306 Distal (lower) end of connector
308 Electric wire interconnect
310 Module or stage
310A First module or stage
310B Second module or stage
312 Housing
311 Upper end of housing
313 Lower end of housing
314 Lens
316 Bulkhead or divider
318 Square O-ring
320 Rod
322 Upper end of rod
324 Lower end of rod
326 Shoulder
330 Imaging tool or camera
340 Lighting element or LED
342 Light sections

### DETAILED DESCRIPTION

A pipeline inspection tool 300 of this disclosure is configured for use in pressurized pipeline environments and adapted for use with a control bar 210 of a first pipeline service machine 200 when connected to a first valve 206 that provides access to the pressurized interior of the pipe 52 through a sidewall of a pipe 52. Similar to plugging tools that are inserted into a pipe in this manner, the inspection tool 300 of this disclosure is an “intrusive tool” as opposed to a “non-intrusive tool,” i.e, a tool pigged into the pipeline from a launcher or from an end of the line. The tool includes a connector 302 adapted for use in a pressurized pipeline. The connector 302 includes an electrical wire interconnect 308 and an is connectable at one end 304 to a distal end 212 of the control bar 210 at another end 306 to uppermost module or stage 310 of the tool 300. The module or stage 310 includes a pressurized housing 312 containing the inspection tool 300. The housing 312 may further include a lens 314.

The tool 300 may include one or more bulkheads or dividers 316 that have a square O-ring 318 and a rod 320 that extends through the bulkhead 316 to place the square O-ring 318 in compression (and thereby sealing against a corresponding upper or lower end 311, 313 of the pressurized housing 312 or the lower end 306 of the connector 202). In some embodiments, the tool 300 includes two modules 310A, 310B, one of which contains an inspection tool 300 and the other of which may contain another inspection tool 300 or a light source 340. For example, one module 310A, 310B may include an imaging tool or camera 330, the other module 310B, 310A may containing lighting elements or LEDs 340, the two modules 310A, 310B comprising a camera or imaging system.

By way of a non-limiting example of an environment of use for embodiments of this disclosure, a structural tool—such as a tapping tool, a plugging tool, or a completion tool of a kind known in the art—is used in combination with a pipeline service machine 100 to perform tapping, plugging (isolation), and completion operations on a section of pipeline 52. The pipeline service machine 100 is of a size suitable for the pipeline. Examples of pipeline service machine 100 and tapping, plugging, and completion tools include, but are not limited to, those manufactured by T.D. Williamson (Tulsa, Oklahoma, USA). A pipeline inspection tool 300 is inserted through another pipeline service machine 200 located down- or upstream of the pipeline service machine 100 to monitor one or more of the service operations performed on the pipeline 52 by way of the pipeline service machine 100. Service machine 200 may be of size smaller than that of service machine 100 because, unlike service machine 100, it is not being used to insert plugging tools into the line. In embodiments of this disclosure, the inspection tools 300 are smaller than the isolation or plugging tools because, unlike plugging tools, the tools 300 do not include means to grip or seal against the pipe wall.

Because pipeline service machine 200 is shown to the left of pipeline service machine 100 in the drawings, machine 200 and its respective inspection tools 300 may be referenced in this disclosure as the first machine or first tool, with machine 100 and its respective structural tools being referenced as the second machine or second tool.

The second pipeline service machine 100 is typically connected to a valve 106 having a sliding gate through which the tapping tool passes to cut an access opening in the sidewall of the pipeline 52. The resulting coupon is then removed through the machine 100 and a plugging or isolation tool is inserted through the valve 106 to block the flow 54 of pipeline product. In some applications, two service machines 100 are used to isolate a section of the pipeline 52 and bypass flow around the section for service. After the service is completed, which may involve removing and replacing the isolated section, the isolation tool is retrieved and a completion tool of a kind known in the art closes the access opening. The pipeline service machine 100 may then be removed.

Embodiments of a system of this disclosure include an inspection tool 300 adapted for connection to a control bar 210 of the first pipeline service machine 200 and then used, in the pressurized pipeline 52, to inspect the product flowing through the pipeline 52, the condition of the pipeline 52, as well as the structural tools of the second pipeline service machine 100 prior to and during their service operations. The second pipeline service machine 100 may be the main or primary pipeline service machine, the first pipeline service machine 200 may be an additional or secondary pipeline service machine.

While not an essential feature of systems and methods of this disclosure, the second pipeline service machine 100 may have a pressure gage 102 and a bleeder valve 104 (as could the first pipeline service machine 200). A platform 101 for machine 100 typically includes the valve 106 connected to a pipeline clamp or saddle 56 having elastomeric seals and a fitting or access flange 60. Equalization piping 110 may connect an upper portion of service machine 100 to a another pipeline clamp 58 located downstream of the service machine 100 relative to product flow 54. Equalization piping 110 may have an equalization valve 112 located at an end nearest the tapping machine 100 and a tapping valve 116 located at the opposite end. Equalization piping 110 may also have a pressure gauge 114 located between tapping valve 116 and equalization valve 112.

Inspection tool 300 may be inserted into the interior of the line through a platform 201 similar to that of the structural tools platform (i.e., a clamp or saddle 256, flange or fitting 260, and valve 206). The inspection tool 300 may be an imaging tool or camera, a velocity measurement tool, an isokinetic measurement tool, a magnetic flux tool, a sound measurement tool for high frequency, oxygen or gas measurement tool, or a gas mixture measurement tool. In embodiments, one or more inspection tools 300 may be deployed sequentially.

In other embodiments, one type of inspection tool 300 may be deployed at a first location along the pipeline 52 and the same or different type of inspection tool 300 may be deployed at another location along the pipeline, either sequentially or at the same time. One inspection tool 300 may be removed and another inserted. Or, the inspection tool 300 may include different modules 310 corresponding to different types of inspection tools 300. In some embodiments, the inspection tool 300 may also be used to inspect the main pipeline service machine 100, including but not limited to its valve 106 and saddle 56.

A system of this disclosure may provide data and information on average velocity measurement, stream velocity profile measurement, gas mixing profile measurement, isokinetic measurement, valve leaking studies including but not limited to high frequency noise, magnetic field studies, and UV, IR, or NIR video analysis. For example, with UV or NIR and the appropriate filtering, an imaging tool or camera 330 of this disclosure can show whether there is thermal variation indicative of a leak around the sealing edges or surfaces of a valve or plugging tool. In some embodiments, a microphone is used along with the camera or NIR so leaks may be identified by two methods.

In embodiments, an inspection tool 300 of this disclosure is adapted for connection to a distal end 212 of a control bar or a tapping bar 202 of the first pipeline service machine 200. The service machine 200 is connected to a platform a sliding gate or ball valve 206. By way of a non-limiting example, service machine 200 may be a TDW® T-101™ or 904™ drilling machine-which is capable of making ½″ to 4″ taps and installing 2″ and 3″ completion plugs-either operated manually or by automated means. Rather than deploying structural tools, however the service machine 200 as used here deploys the inspection tools 300.

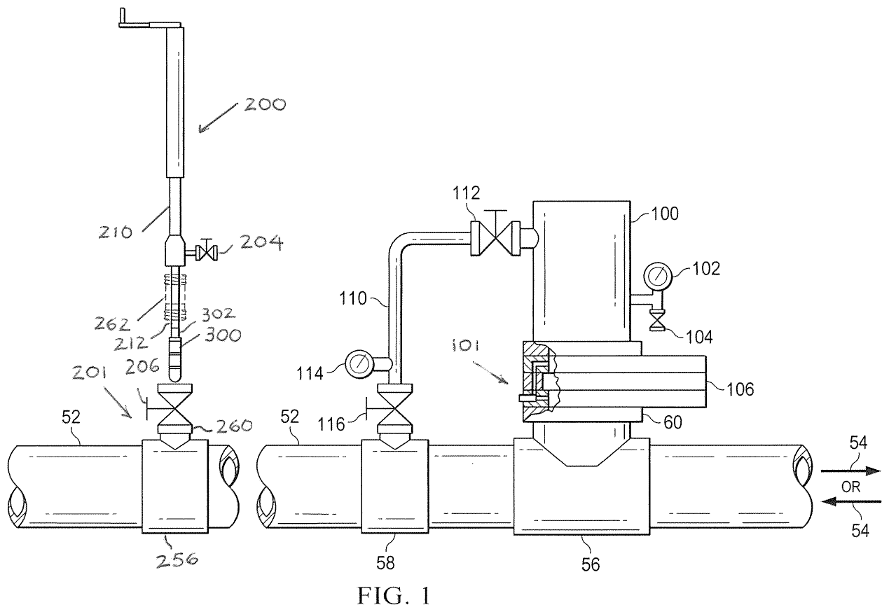

The inspection tool 300 may be placed inside the line 52 at any location where there is an access opening or where a fitting 262, such as a TDW® THREAD-O-RING™ fitting, is located. In some cases, the inspection tool 300 may be deployed through the gate or sandwich valve 106 of the pipeline service machine 100 where, for example, a fitting 260 or 262 for the other pipeline service machine 200 is not warranted or practicable. By way of a non-limiting example, and referring to FIG. 1, the inspection tool 300 could be placed in valve 116, in valve 112 to see the cut area and inspect valve 106, or through the top of the body 100. Multiple inspection tools 300 could be utilized simultaneously to ensure the utmost safety during a given job.

As previously mentioned, pipeline service machine 200 is of a kind typically used for deploying structural tools in hot tapping and adapted for use in deploying the inspection tools 300. However, because it is not deploying the structural tools, it may be of smaller size than that of the second pipeline service machine 100, which must itself be of adequate size to accommodate a plugging or isolation tool of adequate size for the pipeline 52. Pipeline service machine 200 may be placed upstream or downstream of the pipeline service machine 100. For example, pipeline service machine 200 may be placed upstream to look at the working mechanicals (structural tools) of pipeline service machine 100, or it may be placed downstream to look at the seal of the plugging tool inserted by the machine 100 and access whether the seal is holding or leaking. In some embodiments, a pair of pipeline service machines 200 are used, one on each side of the pipeline service machine 100.

In embodiments, inspection tool 300 is connected to the control bar 210 by way of a connector 302 that includes an electric wire interconnect 308, thereby placing the tool 300 in communication with a power source and the controls of pipeline service machine 200. The connector 302 can be one that offers performance comparable to MIL-DTL-38999. In some embodiments, connector 302 includes a GLENAIR® MIGHTY MOUSE™, panel receptacle, high pressure connector or its equivalent. The connector 302 resides between the control bar 210 and the inspection tool 300, a proximal end 304 of the connector 302 connecting to the distal or lower end 212 of the control bar 210 and the distal end 306 of the connector 302 connecting to the upper or top section 301 of the tool 300.

By way of a non-limiting example, the inspection tool 300 may include an imaging tool or camera 330 inserted into the pipeline 52 using the pipeline service machine 200. Because the inspection tool 300 is connected to the control bar 210 of the pipeline service machine 200, the camera 330—or for that matter any inspection tool 300—may be inserted into the pipeline 52 at a desired speed, to a desired initial depth, to a desired initial angle, and in a desired initial orientation. Further, the use of the service machine 200 permits the tool 300 to be inserted into a pressurized line 52.

Once the camera 330 is inserted in the fluid stream while under pressure, a technician can observe the process of tapping and plugging by structural tools of the pipeline service machine 100 during the entire operation. If anything begins to yield inside the line while hot tapping is being performed or while orienting a structural tool into a sealing position or placing it in sealing engagement with the pipe wall, the technician can stop or alter the deployment to ensure that it does not create a catastrophic pathway.

Additionally, the camera 330 may, for example, be used by the technician to locate a coupon (the section of pipeline wall cut out by the drilling machine) if the coupon is dropped during hot tapping, thereby foregoing costly X-ray analysis to find the coupon or significantly reducing the range of X-ray search (and therefore its overall cost). The camera 330 may also be used to locate internal pipe damage, stuck scraper pigs, identify internal obstructions such as a dent, or identify whether previously installed tees are barred to make the pipeline piggable. In some cases, the pipeline service machine 200 is used as a standalone system, independent of the pipeline service machine 100.

The imaging tool or camera 330 may be powered by a low voltage power source such as, but not limited to, 1.0V DC power source. The low voltage serves as a resistance to electrical arcs that could serve as viable ignition sources. Other inspection tools 300 may be powered by the low voltage power source as well.

In embodiments, the imaging tool or camera 330 may be included in a module or stage 310 designed and sized for insertion directly into a gas line as a hot tap application, using the service machine 200 in a substantially same or similar way as structural tools are inserted. The module 310 is surrounded by a housing or enclosure 312 and the housing 312 may include a lens portion 314. The module 310, including housing 312, may be charged with a nitrogen or other inert gas through a high-pressure Schrader valve (e.g. a 5000 psig valve) to decrease the differential pressure experienced by the camera 330 and inert it electrically. Pressurized, prototype examples of the module 310 including a camera 330 have been tested by the inventors to a pressure of 1200 psig. Because the module 310 is pressurized prior to entering the line, the camera 330 can withstand pressures well above the average or normal pipeline pressure, including the maximum allowable pipeline pressure. An inspection tool 300 of this disclosure can be inserted directly into a combustible gas environment that is under an elevated pressure, including pressures up to and exceeding 1600 psig.

In embodiments, the inspection tool 300 may include a first module or stage 310A (or B) and a second module or stage 310B (or A). By way of a non-limiting example, in some embodiments, the first stage 310A is a light module containing LED lights 340 and the second stage 310B is a camera module 310B including an imaging tool or camera 330. The modules 310A, 310B may removably interlock or interconnect with one another.

In embodiments, a bulkhead or divider 316 serves as the connector. Where a camera 340 and LED lights 340 are used, the divider 216 serves to isolate the module or stage 310 containing the camera 340 from reflected light, originating from the module or stage 310 containing the lights 340, which could blind the camera 340. The divider 316 can also serve to isolate a tool 300 in a first stage 310A from that of another tool 300 in a second stage 310B. In some embodiments, two tools 300 may be included in a single stage 310A or 310B.

Each divider 316 provides for sealing between adjacent modules 310. In embodiments, the divider 316 at least one set of square O-rings 318 or their equivalent. A rod 320 extends through the dividers 316, with the lower end 324 of the rod 320 received by a shoulder 326. An upper end 322 of the rod 320 is received by the connector 302. As the rod 320 is tightened, the square O-rings 318 compress and form a seal between the adjacent modules 310. The square O-rings 318 also provide sealing engagement between the tool 300 and the connector 302 (or control bar 210).

Additional light and imaging or camera modules 310A, 310B may be included such that two or three or more cameras 330 are deployed in a single inspection tool 300. For example, one camera 330 can be looking upstream, another camera 330 looking downstream, and a third camera 330 looking down at the pipe floor. Or, in larger piping systems, two cameras 330 could be looking in a single direction to gain a better view, with a light module 310A separating the two camera modules 310B. The camera modules 310B may be rotated when deployed to gain any angle of view or height as needed. The camera modules 310B may be filtered to allow near infrared analysis.

The modular arrangement 310 allows the tool 300 to be configured in many different geometries as needed for any given job. For example, in some embodiments, and using camera 330 as an example, the camera module 310B is less than 3 inches, less than 2½ inches, or less than 2¼ inches in height. Another camera module 310B may be less than 2 inches in diameter for deployment through standard fittings. The small size of the modules 310 allows the entirety of the system to be protected within the confines of the housing or fitting 260 and the sliding gate or ball valve 206 to which the first pipeline service machine 200 connects without additional lengths being added to the housing 260 or the valve 206. In other words, no modification is required to the existing hot tapping platform in order to accommodate the inspection tool 300 or an embodiment of the tool 300 including a camera 330 when in use with the first pipeline service machine 200.

Each tool 300 within each module 310 may be selectively controlled independent of other modules 310 by a controller. For example, the camera 330 or module 310, or a portion thereof, may be rotated when in deployment as needed to obtain the optimum or best image of a target or object of interest. In many cases the images wanted are relevant to damage in the line 52 that will help to determine whether the line 52 will need to be plugged and repaired, or even taken down or decommissioned.

In embodiments of a light module 310 of this disclosure, the light module 310 includes one or more light sections 342 comprising individual LED light elements 340. By way of a non-limiting example, a module 310 or section of the module 310 may include as many as 8 light elements 340. Each of the light modules 310, sections 342 or elements 340 can be individually controlled by the controller to allow for the light to be tempered as needed.

In some embodiments, the camera 330 or its module 310 includes a filter to gain a range of view into the UV or IR spectrum. Using the filter, the camera module 310 can detect where there is a temperature differential indicative of a leaky valve or the presence of organisms inside the line generating heat. The temperature difference could potentially sufficient to identify against the bulk temperature in the line. The use of the camera 330 to identify this temperature difference could therefore be useful in finding leaking valves, especially when under high pressure. Again, a microphone in use with the camera 340 can also be used to identify high frequency noise indicative of a leak and may be used in tandem with an NIR lens.

The camera module 310, as with other inspection tool modules 310 of this disclosure, may be controlled with a dedicated control panel. The control panel/box may be internet or satellite connected, allowing the images taken to be sent directly anywhere in the world for direct review. In embodiments, the control may include a video screen or display that allows the operator to see in real time what the camera 330 is seeing such that adjustments can be made to allow better angles, adjust zoom, or change lighting to make sure the appropriate images and clearer images are taken. In embodiments, the camera module 310 is controllable to capture still shots or video as needed. Once the appropriate images have been secured, the images can be saved and downloaded to a laptop while the camera 330 remains in the line. Engineering staff can review the video or close up images to make quick decisions that previously would have taken days or weeks to determine whether a pipe section was unsafe and should be removed or sectioned and repaired.

The camera module 310 or the inspection tool 300 may include its own safety sensors relative to temperature and pressure while in use. Should the camera 330 or one of its camera modules 310B begin to overheat—for example, because of the lighting module 310A—the camera 330 or module 310 can automatically shut down and remain shut down until the internal environment is cool enough to support the use of the camera 330 and lights 340 once again. The convective cooling of the flowing gas passing by the camera module 310 should quickly cool the interior of the camera 330 and allow the camera 330 to once again be ready for service.

In embodiments of a method of this disclosure, the method comprises providing a pipeline inspection tool 300 of this disclosure; inserting the pipeline inspection tool 300 through a valve 206 of the first pipeline service machine 200 and into an interior of the pipeline 52; and using the inspection tool 300 to collect data that corresponds to a pipeline condition, a pipeline product or flow condition, a condition of the second pipeline service machine 100 including the structural tool and the second valve 106, an operation performed by the second pipeline service machine 100, or some combination thereof.

The method may include the controller controlling the pipeline inspection tool 300 when collecting the data and analyzing the collected data. The method may further include, if the analyzed data indicates a safe condition, inserting a structural tool through the second valve 106, deploying the structural tool; and monitoring the deploying or operation of the structural tool with the pipeline inspection tool 300.

While embodiments of this disclosure have been described in detail and in reference to the drawings, the scope of the invention is defined by the following claims, the elements of which are entitled to their full range of equivalents.

1. A pipeline inspection tool (300) adapted for use with a first pipeline service machine (200), including a control bar (210), when connected to a first valve (206) providing access to an interior of a section of pipe (52) through a sidewall of the pipe, the pipeline inspection tool selected from the group consisting of an imaging tool, a velocity measurement tool, an isokinetic measurement tool, a sound tool, a magnetic flux tool, and a gas mixture measurement tool, the inspection tool comprising:
a connector (302) adapted for use in a pressurized pipeline, the connector including an electrical wire interconnect (308) and connectable at one end (304) to a distal end (210) of the control bar; and
a first module (310, 310A, 310B) connectable to another end (306) of the connector, the first module including a pressurized housing (312) containing the inspection tool.

2. The pipeline inspection tool of claim 1, further comprising the pressurized housing including a bulkhead (316) having at least one square O-ring (318).

3. The pipeline inspection tool of claim 2, further comprising a rod (320) extending through the bulkhead, the rod arranged, when tightened, to place the at least one square O-ring in compression.

4. The pipeline inspection tool of claim 2, further comprising a second module (310, 310A, 310B) including the pressurized housing and connected to the first module, the bulkhead lying between and connecting the first and second modules.

5. The pipeline inspection tool of claim 4, wherein at least one of the first and second modules includes a second pipeline inspection tool (300) selected from the group consisting of an imaging tool, a velocity measurement tool, an isokinetic measurement tool, a sound tool, a magnetic flux tool, and a gas mixture measurement tool.

6. The pipeline inspection tool of claim 4, wherein the second module is a lighting module containing a lighting element (340).

7. The pipeline inspection tool of claim 6, wherein the first module includes the imaging tool.

8. The pipeline inspection tool of claim 7, wherein the imaging tool is a camera (330).

9. The inspection tool of claim 1, further comprising a controller in communication with at least one of the connector and the pipeline inspection tool, the controller including non-transitory computer-readable storage medium containing instructions thereon.

10. A pipeline service system comprising the pipeline inspection tool of claim 1, wherein the pipeline service system includes a second pipeline service machine (100) spaced apart from the first pipeline service machine and connected to a second valve (106) providing access to an interior of the section of pipe through a sidewall of the pipe, the second pipeline service machine including at least one structural tool selected from the group consisting of a drilling tool, a plugging tool, and a completion tool.

11. A method for monitoring a section of pipe (52) using the pipeline inspection tool of claim 1, the method comprising:
inserting the pipeline inspection tool into an interior of a section of pipe (52) through a first valve (206) providing access to an interior of the section of pipe through a sidewall of the pipe, the section of pipe being pressurized and containing a pipeline product; and
after the inserting, collecting data, using the pipeline inspection tool; and
analyzing the collected data;
wherein the collected data corresponds to at least one of a pipeline condition, a pipeline product or flow condition, a condition of a second pipeline service machine (100) including a structural tool and a second valve (106) to which the second pipeline service machine is attached, and an operation performed by the second pipeline service machine;
wherein the structural tool is selected from the group consisting of a drilling tool, a plugging tool, and a completion tool.

12. The method of claim 11, further comprising: if the analyzed collected data indicates a safe condition, then
inserting the structural tool through the second valve; and
during the inserting, collecting additional data using the pipeline inspection tool.

13. The method of claim 11, wherein the pipeline inspection tool is in communication with a controller including non-transitory computer-readable storage medium containing instructions thereon.

14. The method of claim 11, wherein the pipeline inspection tool is an imaging tool.

15. The method of claim 14, wherein the imaging tool is a camera (330).
